(19) United States
(12) Patent Application Publication
(10) Pub. No.: US 2007/0193397 A1
(43) Pub. Date: Aug. 23, 2007

(54) Structure of shift lever head

(75) Inventor: Jui-Bin Hwan, Taipei City (TW)

Correspondence Address: BACON & THOMAS, PLLC, 625 SLATERS LANE, FOURTH FLOOR, ALEXANDRIA, VA, 22314, US

(73) Assignee: Great Performance Industrial Co., Ltd, Taipei Hsien (TW)

(21) Appl. No.: 11/348,407

(22) Filed: Feb. 7, 2006

(51) Int. Cl. G05G 1/04

(52) U.S. Cl. 74/523

(57) ABSTRACT

A structure of shift lever head for a car with which the modeling of the shift lever can be changed at one's will; it comprises: a main body of the shift lever head; a lower decoration plate fixed on the top surface of the main body of the shift lever head; and an upper decoration plate fixed on the top surface of the lower decoration plate, after a locking hole of the lower decoration plate is locked onto the upper decoration plate by means of a locking element, another locking element is used to lock the lower decoration plate together with the main body of the shift lever head; thus the completed shift lever head for a car is formed, by changing the modeling of the lower and the upper decoration plates, the modeling of the shift lever can be changed at one's will.

### BACKGROUND OF THE INVENTION

1. Field of the Invention

The present invention is related to a structure of shift lever head for a car, and especially to an improved structure with which the modeling of the shift lever can be changed at one's will; the structure of a shift lever head comprises: a main body of the shift lever head, a lower decoration plate, an upper decoration plate and an annular sleeve.

2. Description of the Prior Art

With nonstop advancing of the industrial car technique, and under the selling competitions in car consumption, increasing of periphery equipment of cars continuously tends to getting more and more luxurious; for instance, modeling of electric seats, skylights and instruments etc. is improved and innovated from time to time; however, the shift levers that drivers most often touch in driving have had no improvement all along, the shift levers most important to driving speed of cars are always neglected in their beautifying and sumptuousness.

Conventional shift lever heads are all formed integrally and are slipped over shift levers directly; hence when in changing shift lever heads, the old shift lever heads shall be detached to discard, this makes awful wasting of material used.

Besides, conventional shift lever heads for cars have smooth domed surfaces; when a user wants to shift gear in driving, danger may often be induced because of slipperiness of the dome shaped shift lever head of his car.

### SUMMARY OF THE INVENTION

In view of the above stated problems, the inventor of the present invention provides a structure of shift lever head for a car based on his professional experience of years in studying, designing and manufacturing same kind of products and after hard study and developing.

The present invention is a structure of shift lever head for a car, the structure comprises: a main body of the shift lever head, a lower decoration plate, an upper decoration plate and an annular sleeve.

Wherein the main body of the shift lever head has on its bottom a slipping connecting hole for slipping therein of a shift lever, and has on its top a hole and an engaging groove, the hole is extended downwards through the main body of the shift lever head to communicate with the slipping connecting hole; the main body of the shift lever head is provided on its bottom end with an engaging collar surrounding the slipping connecting hole, and the slipping connecting hole of the main body of the shift lever head is provided therein with a connecting member for slipping connecting which further includes an inner annular sleeve lining and an elastic element for slipping over the shift lever; and more, a lower portion of the main body of the shift lever head and the inner annular sleeve lining of the connecting member are provided each with a radial fixing hole to align with each other, thereby a fixing element can be extended through these radial fixing holes for fixing on the shift lever.

The lower decoration plate is provided on its top surface with a plurality of protrusions and a locking hole, its bottom surface is provided with a screw connecting portion and an engaging block in cooperation with the hole and the engaging groove.

The upper decoration plate is provided with a plurality of positioning grooves to align and connect with the protrusions of the lower decoration plate, and is provided with a screw connecting portion to align with the locking hole; and after the locking hole of the lower decoration plate is locked onto the screw connecting portion of the upper decoration plate by means of a locking element, another locking element is used to lock the lower decoration plate together with the main body of the shift lever head from the hole above the slipping connecting hole.

The annular sleeve is a hollow cylinder located beneath the main body of the shift lever head, one end of the annular sleeve is slipped over the shift lever, and another end is provided with an engaging portion surrounding the annular sleeve and is engaged with the engaging collar of the main body of the shift lever head; so that the lower decoration plate is connected with the upper decoration plate, and then is connected with the main body of the shift lever head, and lastly is engaged with the annular sleeve to form the completed shift lever head for a car.

According to the above stated, the object of the present invention is to render the modeling of the shift lever head to be changed at one's will by connection of the protrusions of the lower decoration plate with the positioning grooves of the upper decoration plate and by locking with the locking elements.

Another object of the present invention is to render a driver to get a slipping-proof effect for his hand when in shifting gear during driving by having connecting of the upper decoration plate with the lower decoration plate, in which the protrusions of the lower decoration plate still partially protrude upwardly out of the positioning grooves of the upper decoration plate.

The present invention will be apparent in its content and effects to be achieved after reading the detailed description of the preferred embodiment thereof in reference to the accompanying drawings.

### BRIEF DESCRIPTION OF THE DRAWINGS

FIG. 1 is an anatomic perspective view of the first embodiment of the present invention;

FIG. 2 is an anatomic and schematic sectional view of the first embodiment of the present invention;

FIG. 3 is a schematic sectional view of the first embodiment of the present invention;

FIG. 4 is a sectional view of the second embodiment of the present invention;

FIG. 5 is a schematic sectional view showing operation of the second embodiment of the present invention.

### DETAILED DESCRIPTION OF THE PREFERRED EMBODIMENT

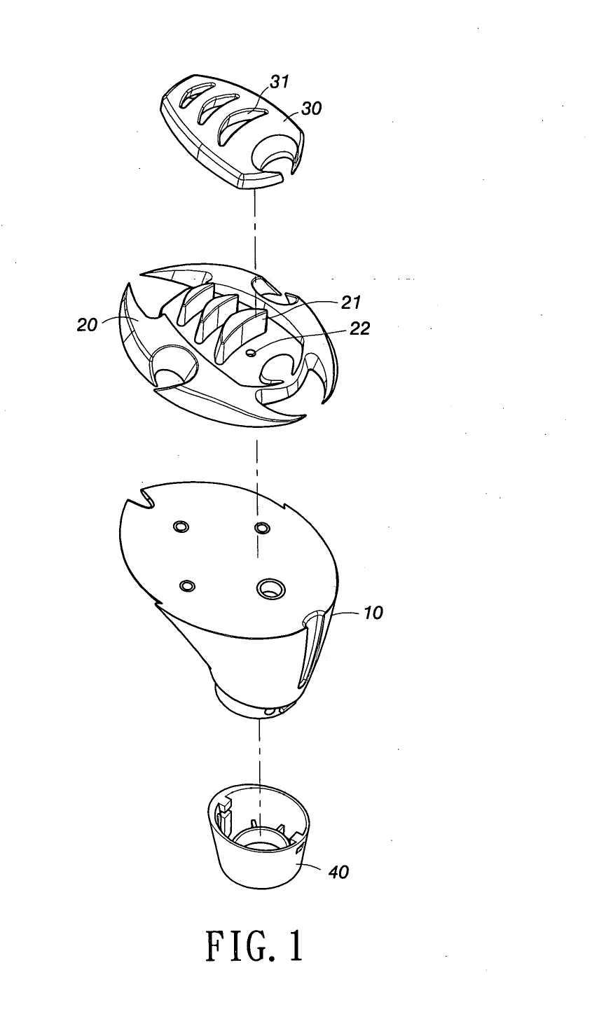

Referring to FIG. 1 which is an anatomic perspective view of the first embodiment of a structure of shift lever head for a car of the present invention, the structure comprises: the shift lever head for a car having a main body 10 of the shift lever head, a lower decoration plate 20, an upper decoration plate 30 and an annular sleeve 40.

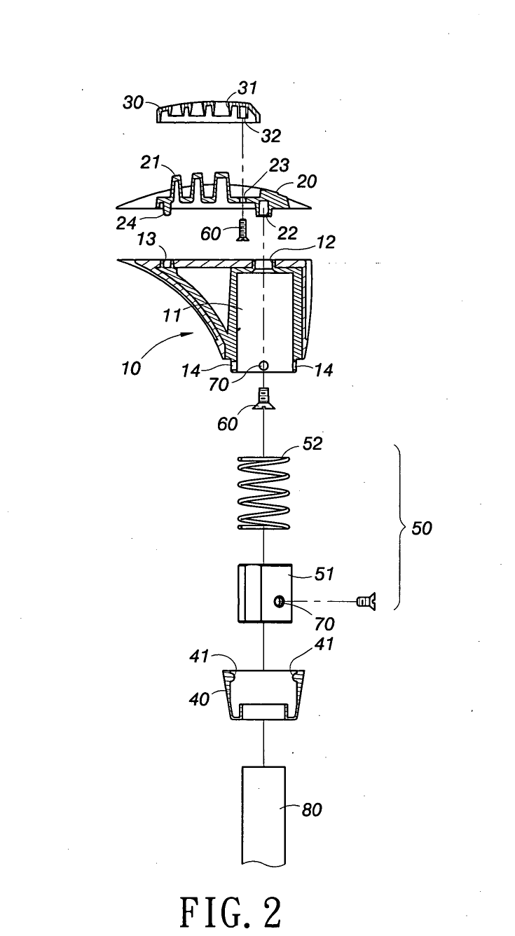

FIG. 2 is an anatomic perspective and schematic sectional view of the first embodiment of the present invention, wherein the main body 10 of the shift lever head has on its bottom a slipping connecting hole 11 for slipping therein of a shift lever 80, and has on its top a hole 12 and an engaging groove 13, the hole 12 is extended downwards through the main body 10 of the shift lever head to communicate with the slipping connecting hole 11; the main body 10 of the shift lever head is provided on its bottom end with an engaging collar 14 surrounding the slipping connecting hole 11, and the slipping connecting hole 11 of the main body 10 of the shift lever head is provided therein with a connecting member 50 for slipping connecting which further includes an inner annular sleeve lining 51 and an elastic element 52 for slipping over the shift lever 80; and more, a lower portion of the main body 10 of the shift lever head and the inner annular sleeve lining 51 of the connecting member 50 are provided each with a radial fixing hole 70 to align with each other, thereby a fixing element can be extended through these radial fixing holes 70 for fixing the shift lever 80.

The lower decoration plate 20 is provided on its top surface with a plurality of protrusions 21 and a locking hole 23, its bottom surface is provided with a screw connecting portion 22 and an engaging block 24 in cooperation with the hole 12 and the engaging groove 13.

The upper decoration plate 30 is provided with a plurality of positioning grooves 31 to align and connect with the protrusions 21 of the lower decoration plate 20, and is provided with a screw connecting portion 32 to align with the locking hole 23; and after the locking hole 23 of the lower decoration plate 20 is locked onto the screw connecting portion 32 of the upper decoration plate 30 by means of a locking element 60, another locking element 60 is used to lock the lower decoration plate 20 together with the main body 10 of the shift lever head from the hole 12 above the slipping connecting hole 11.

The annular sleeve 40 is a hollow cylinder located beneath the main body 10 of the shift lever head, one end of the annular sleeve 40 is slipped over the shift lever 80, and another end is provided with an engaging portion 41 surrounding the inside of the annular sleeve 40 and is engaged with the engaging collar 14 of the main body 10 of the shift lever head.

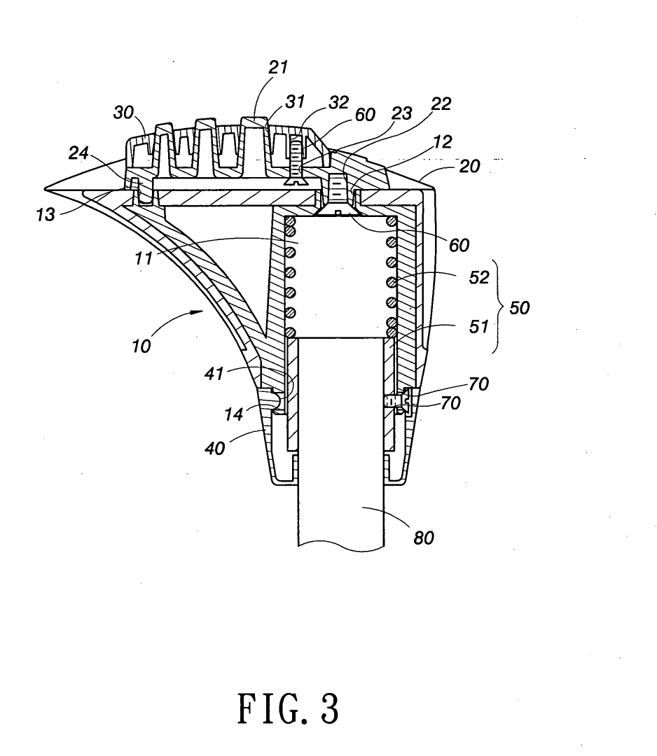

Referring to FIG. 1 and FIG. 3 which is a schematic sectional view of the first embodiment of the present invention, wherein the protrusions 21 of the lower decoration plate 20 are connected with their corresponding positioning grooves 31 of the upper decoration plate 30, and the locking elements 60 are used to lock the screw connecting portion 32 of the upper decoration plate 30 together with the locking hole 23 of the lower decoration plate 20.

Then the engaging groove 13 of the main body 10 of the shift lever head is aligned and engaged with the engaging block 24 of the lower decoration plate 20, and a locking element 60 is used to extend through the slipping connecting hole 11 of the main body 10 of the shift lever head from below to lock the hole 12 of the main body 10 of the shift lever head together with the screw connecting portion 22 of the lower decoration plate 20, thereby the main body 10 of the shift lever head can be connected with the lower decoration plate 20.

Lastly, the hollow cylindrical annular sleeve 40 is slipped over the shift lever 80, then the inner annular sleeve lining 51 of the connecting member 50 is slipped over the shift lever 80, also the elastic element 52 is slipped over the shift lever 80, the elastic element 52 is placed on the inner annular sleeve lining 51, and then the completed assembly including the lower decoration plate 20, the upper decoration plate 30 and the main body 10 is all together further slipped over the shift lever 80, and the elastic element 52 as well as the inner annular sleeve lining 51 are received in a receiving space in the main body 10, the shift lever head is completed by engaging of the engaging portion 41 of the annular sleeve 40 with the engaging collar 14 of the main body 10 of the shift lever head, and further by fixing the radial fixing holes 70 respectively of the main body 10 and the inner annular sleeve lining 51 onto the shift lever 80.

At this time, the inner annular sleeve lining 51 of the connecting member 50 and the elastic element 52 are received in the slipping connecting hole 11 of the main body 10 of the shift lever head, and by having the main body 10 of the shift lever head received between the inner annular sleeve lining 51 and the slipping connecting hole 11, the distance for pressing the main body 10 of the shift lever head can be increased, this can avoid undue position displacement by inadvertent pressing the shift lever head.

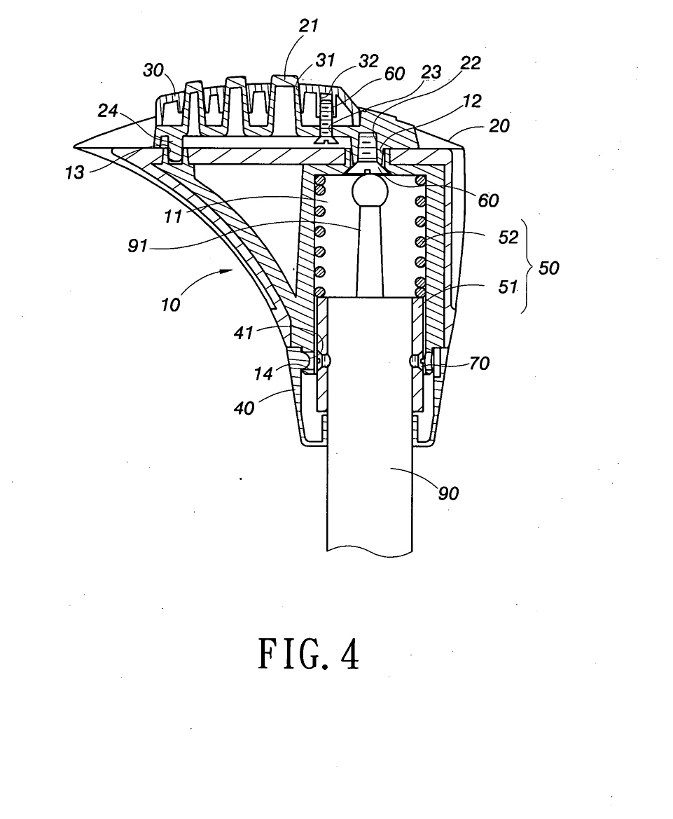

Please refer to FIG. 4 which is a sectional view of the second embodiment of the present invention, wherein the inner annular sleeve lining 51 is locked on an automatic shift lever 90, the automatic shift lever 90 is provided thereon with a gear-position link 91 for control locking of gear positions; the inner annular sleeve lining 51 and the slipping connecting hole 11 movably cooperate with other and are limited by the annular sleeve 40 to render the shift lever head to get a stroke for raising and lowering.

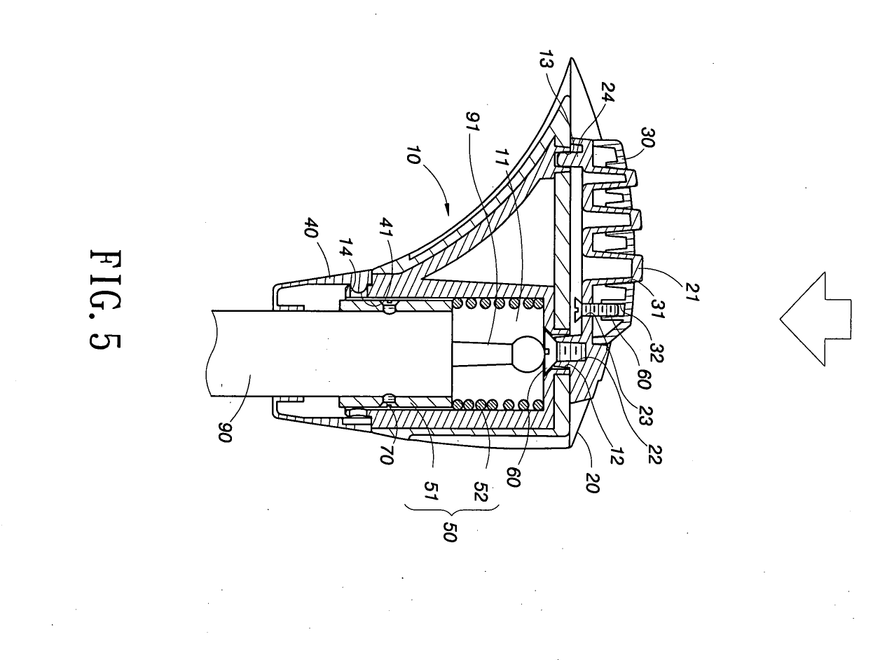

As shown in FIG. 5 which is a schematic sectional view showing the operation of the second embodiment of the present invention, when the shift lever head is lowered by pressing, the shift lever head will abut the gear-position link 91 to make the automatic shift lever 90 change gear positions; on the contrary, when the shift lever head under pressing is raised by the restoration action of the gear-position link 91 and the elastic element 52, the gear position of the automatic shift lever 90 can thus be locked.

However, the embodiment given and the drawings are only for illustrating the present invention, and not for giving any limitation to the scope of the present invention; it will be apparent to those skilled in this art that various equivalent modifications or changes without departing from the spirit of this invention shall also fall within the scope of the appended claims.

1. A structure of shift lever head for a car comprising:
a main body of said shift lever head having on its bottom a slipping connecting hole for slipping therein of a shift lever, and having on its top a hole and an engaging groove, said hole is extended downwards through said main body of said shift lever head to communicate with said slipping connecting hole;
a lower decoration plate provided on its top surface with a plurality of protrusions and a locking hole, its bottom surface is provided with a screw connecting portion and an engaging block in cooperation with said hole and said engaging groove;
an upper decoration plate provided with a plurality of positioning grooves to align and connect with said protrusions, and provided with a screw connecting portion to align with said locking hole, after said locking hole of said lower decoration plate is locked onto said screw connecting portion of said upper decoration plate by means of a locking element, said lower decoration plate and said main body of said shift lever head are locked together.

2. The structure of shift lever head for a car as claimed in claim 1, wherein said main body of said shift lever head is provided on its bottom end with an engaging collar surrounding said slipping connecting hole to connect with and fix an annular sleeve.

3. The structure of shift lever head for a car as claimed in claim 2, wherein said slipping connecting hole of said main body of said shift lever head is provided therein with a connecting member above said annular sleeve.

4. The structure of shift lever head for a car as claimed in claim 3, wherein said connecting member further is provided with an inner annular sleeve lining and an elastic element.

5. The structure of shift lever head for a car as claimed in claim 4, wherein a lower portion of said main body of said shift lever head and said inner annular sleeve lining of said connecting member are provided each with a radial fixing hole to align with each other, and a fixing element is extended through said radial fixing holes for fixing said shift lever head on said shift lever.

6. The structure of shift lever head for a car as claimed in claim 3, wherein said inner annular sleeve lining is locked on an automatic shift lever, said automatic shift lever is provided thereon with a gear-position link; said inner annular sleeve lining and said slipping connecting hole movably cooperate with other and are limited by said annular sleeve to render said shift lever head to get a stroke for raising and lowering; when said shift lever head is lowered by pressing, said shift lever head abuts said gear-position link to make said automatic shift lever release fixing of gear positions; when said shift lever head under pressing is raised by restoration actions of said gear-position link and said elastic element, a gear position of said automatic shift lever thus is locked.
